(19) United States
(12) Patent Application Publication
(10) Pub. No.: US 2026/0257955 A1
(43) Pub. Date: Sep. 3, 2026

(54) APPARATUS AND METHOD FOR REDUCING DEFECTS IN GLASS MELT VESSELS

(71) Applicant: CORNING INCORPORATED, Corning, NY (US)

(72) Inventor: JinSoo Kim, Asan (KR)

(21) Appl. No.: 19/490,000

(22) PCT Filed: May 17, 2024
(86) PCT No.: PCT/US2024/029859

§ 371 Date: Dec. 4, 2025

Related U.S. Application Data
(60) Provisional application No. 63/508,329, filed on Jun. 15, 2023.

(51) Int. Cl. C03B 5/167; C03B 5/425

(52) U.S. Cl. CPC C03B 5/1675; C03B 5/425

(57) ABSTRACT

An apparatus and method for manufacturing a glass article includes a mixing vessel having a wall circumferentially surrounding an inner chamber and a rotatable center shaft, a removable lid covering the inner chamber and circumferentially surrounding the rotatable center shaft, and a condensate catcher positioned between the removable lid and the wall.

### CROSS-REFERENCE TO RELATED APPLICATIONS

This application claims the benefit of priority under 35 U.S.C. § 119 of U.S. Provisional Application Ser. No. 63/508,329 filed on Jun. 15, 2023, the content of which is relied upon and incorporated herein by reference in its entirety.

### FIELD

The present disclosure relates generally to glass melting systems and particularly to apparatuses and methods for reducing defects in glass melting vessels.

### BACKGROUND

In the production of glass articles, such as glass sheets for display applications, including televisions and hand-held devices, such as telephones and tablets, molten glass is transported through a glass melting system. The glass melting system typically includes vessels or conduits comprising a precious metal or precious metal alloy, wherein molten glass is transported through the vessels or conduits, physically contacting the precious metal or precious metal alloy. Such contact between the molten glass and the precious metal or precious metal alloy can lead to chemical reactions, such a redox reactions, wherein a precious metal or precious metal oxide is transported into the molten glass or on the molten glass surface. The presence of such precious metal or precious metal oxide in the molten glass or on the molten glass surface can result in undesirable defects in the glass articles. In addition, such reactions can result in corrosion of the vessels or conduits of the glass melting system, which can, in turn, result in the need to repair or replace such components as well as undesirable process down time. Accordingly, it would be desirable to mitigate or inhibit these effects.

### SUMMARY

Embodiments disclosed herein include a glass mixing vessel that includes a wall circumferentially surrounding an inner chamber and a rotatable center shaft, a removable lid covering the inner chamber and circumferentially surrounding the rotatable center shaft, and a condensate catcher positioned between the removable lid and the wall. The condensate catcher includes a vertically extending surface and a horizontally extending surface. The vertically extending surface has an inner diameter that is greater than an inner diameter of the horizontally extending surface.

Embodiments disclosed herein also include a method of manufacturing a glass article. The method includes processing molten glass within a glass mixing vessel. The glass mixing vessel includes a wall circumferentially surrounding an inner chamber and a rotatable center shaft, a removable lid covering the inner chamber and circumferentially surrounding the rotatable center shaft, and a condensate catcher positioned between the removable lid and the wall. The condensate catcher includes a vertically extending surface and a horizontally extending surface. The vertically extending surface has an inner diameter that is greater than an inner diameter of the horizontally extending surface.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic side cutaway view of a portion of an example mixing vessel in accordance with embodiments disclosed herein;

FIG. 3 is a schematic top cutaway view of the example mixing vessel of FIG. 2;

FIG. 4 is a schematic side cutaway view of a portion of an example mixing vessel in accordance with embodiments disclosed herein;

FIG. 5 is another schematic side cutaway view of the example mixing vessel of FIG. 4;

FIG. 6 is a schematic top cutaway view of the example mixing vessel of FIGS. 4 and 5; and

FIG. 7 is a schematic side cutaway view of a portion of an example condensate catcher and blocking ring in accordance with embodiments disclosed herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “molten glass” refers to a glass composition that is at or above its liquidous temperature (the temperature above which no crystalline phase can coexist in equilibrium with the glass).

As used herein, the term “free surface of the molten glass” refers to an area where molten glass contacts an atmosphere above the molten glass.

As used herein the term “conduit” refers to a conduit or vessel of a glass manufacturing apparatus that is configured to flow molten glass therethrough. Non-limiting exemplary conduits include mixing vessel 36, fining vessel 34, delivery vessel 40, and connecting conduits.

As used herein, the term “connecting conduit” refers to a conduit used to connect components of a glass manufacturing apparatus and configured to flow molten glass therethrough. Non-limiting exemplary connecting conduits disclosed herein include first connecting conduit 32, second connecting conduit 38, and third connecting conduit 46.

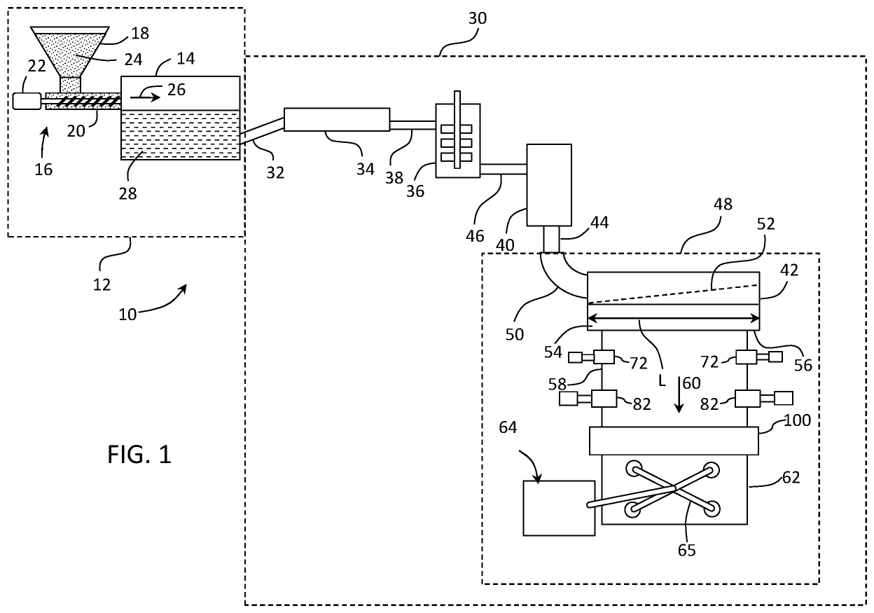

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 includes one or more additional components, such as heating elements (as will be described in more detail herein) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw batch materials 24 that can be fed into melting vessel 14 of glass melting furnace 12, as indicated by arrow 26. Raw batch materials 24 typically comprise one or more glass forming metal oxides and one or more modifying agents. In some examples, raw material delivery device 20 can be powered by motor 22 such that raw material delivery device 20 delivers a predetermined amount of raw batch materials 24 from the storage bin 18 to melting vessel 14. In further examples, motor 22 can power raw material delivery device 20 to introduce raw batch materials 24 at a controlled rate based on a level of molten glass sensed downstream from melting vessel 14. Raw batch materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 100% to about 60% by weight platinum and about 0% to about 40% by weight rhodium. However, other suitable metals can include molybdenum, rhenium, tantalum, titanium, tungsten and alloys thereof. Oxide Dispersion Strengthened (ODS) precious metal alloys are also possible.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw batch materials 24 may include multivalent compounds (i.e., fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

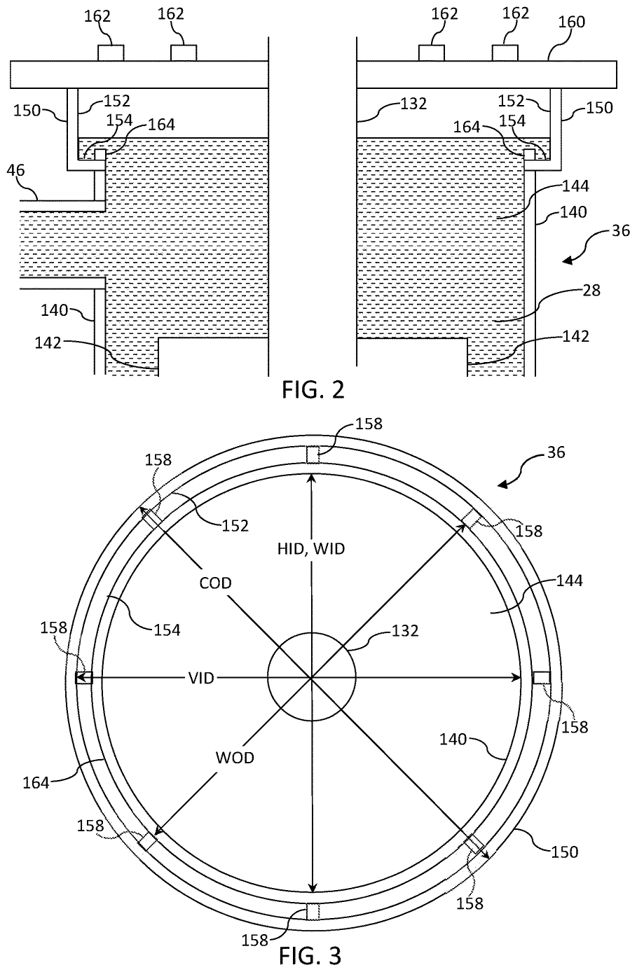

FIG. 2 shows a schematic side cutaway view of a portion of an example mixing vessel 36 in accordance with embodiments disclosed herein. Mixing vessel 36 is configured to process molten glass 28 and includes a wall 140 that circumferentially surrounds an inner chamber 144 that contains molten glass 28. Wall 140 also circumferentially surrounds a rotatable center shaft 132 from which stirring blades 142 extend. In addition, mixing vessel 36 includes a removable lid 160 that is configured to cover the inner chamber 144 and circumferentially surround the rotatable center shaft 132. Removable lid 160 is configured to allow rotatable center shaft 132 to extend therethrough and may, for example, comprise two approximately semi-circular segments that extend in clamshell fashion around rotatable center shaft 132. Removable lid 160 may be secured to the remainder of mixing vessel via bolts 162.

Mixing vessel 36 also includes a condensate catcher 150 positioned between the removable lid 160 and the wall 140. Condensate catcher 150 comprises a generally circular cross-section that may include two semi-circular segments joined or welded together. Condensate catcher 150 includes a vertically extending surface 152 and a horizontally extending surface 154. FIG. 3 shows a schematic top cutaway view of the example mixing vessel 36 of FIG. 2. As shown in FIG. 3, vertically extending surface 152 of condensate catcher 150 has an inner diameter VID that is greater than an inner diameter HID of the horizontally extending surface 154. In addition, outer diameter COD of condensate catcher 150 is greater than outer diameter WOD of wall 140. As further shown in FIG. 3, inner diameter HID of horizontally extending surface 154 equals inner diameter WID of wall 154.

In the embodiment shown in FIGS. 2 and 3, condensate catcher 150 is permanently affixed to wall 140. For example, condensate catcher 150 may be welded to wall 140 in accordance with methods known to persons having ordinary skill in the art. In such embodiment, removable lid 160 may be removably attached to condensate catcher 150 via bolts 162. In addition, a blocking ring 164 extends along an inner diameter of horizontally extending surface 154 and plurality of gussets 158 extend radially along horizontally extending surface 154. Blocking ring 164 can help contain condensate within condensate catcher 150 and plurality of gussets 158 can help maintain generally cylindrical shape of wall 140 and vertically extending surface 152 during operation.

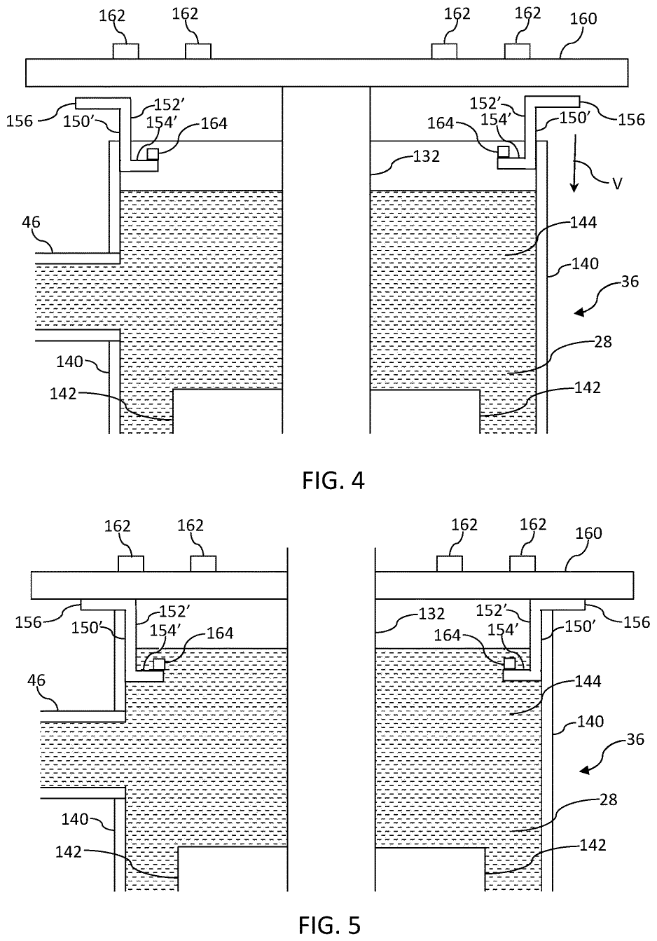

FIGS. 4 and 5 show a schematic side cutaway view of a portion of another example mixing vessel 36 in accordance with embodiments disclosed herein. As with the embodiments shown in FIGS. 2 and 3, mixing vessel 36 is configured to process molten glass 28 and includes a wall 140 that circumferentially surrounds an inner chamber 144 that contains molten glass 28. Wall 140 also circumferentially surrounds a rotatable center shaft 132 from which stirring blades 142 extend. In addition, mixing vessel 36 includes a removable lid 160 that is configured to cover the inner chamber 144 and circumferentially surround the rotatable center shaft 132. Removable lid 160 is configured to allow rotatable center shaft 132 to extend therethrough and may, for example, comprise two approximately semi-circular segments that extend in clamshell fashion around rotatable center shaft 132. Removable lid 160 may be secured to the remainder of mixing vessel via bolts 162.

Mixing vessel 36 also includes a condensate catcher 150′ positioned between the removable lid 160 and the wall 140. Condensate catcher 150′ comprises a generally circular cross-section that may include two semi-circular segments joined or welded together. Condensate catcher 150′ includes a vertically extending surface 152′, a horizontally extending surface 154′, and a horizontally extending flange 156. In addition, a blocking ring 164 extends along an inner diameter of horizontally extending surface 154.′

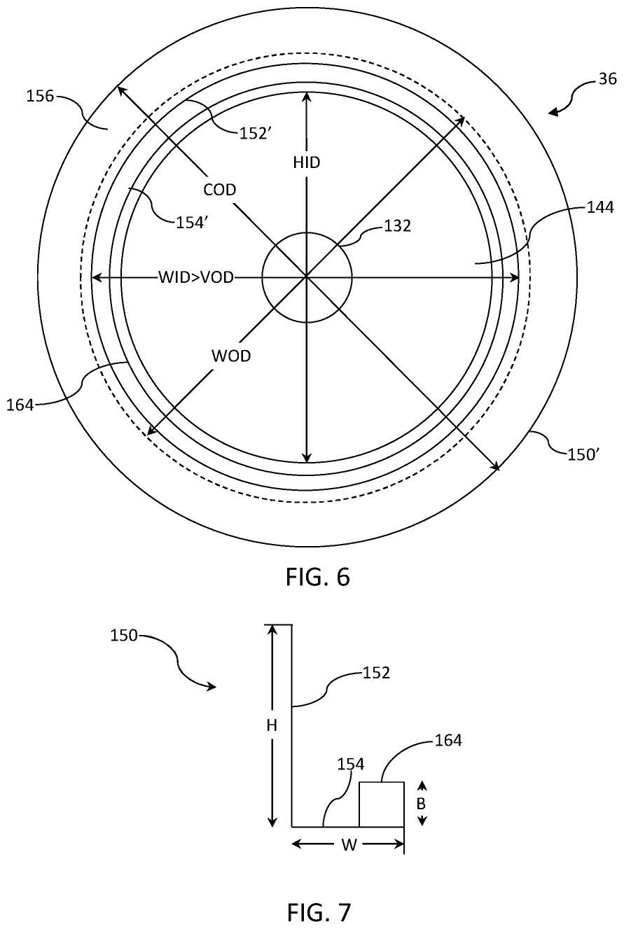

As shown in FIGS. 4 and 5, condensate catcher 150′ is removably inserted between removable lid 160 and wall 140. Specifically, as shown in FIG. 4, condensate catcher 150′ is movable in a vertical direction (as shown by arrow V) into an upper portion of wall until, as shown in FIG. 5, horizontally extending flange 156 rests on top of wall 140. As shown in FIG. 4-6, outer diameter VOD of vertically extending surface 152′ is less than inner diameter WID of wall 140. In addition, outer diameter COD of condensate catcher 150′ is greater than outer diameter WOD of wall 140. As further shown in FIG. 6, inner diameter HID of horizontally extending surface 154 is less than inner diameter WID of wall 154.

FIG. 7 shows a schematic side cutaway view of a portion of an example condensate catcher 150 and blocking ring 164 in accordance with embodiments disclosed herein. In certain exemplary embodiments, vertically extending surface 152, 152′ extends a vertical distance (shown by double arrow H in FIG. 7) large enough to immerse horizontally extending surface 154, 154′ in molten glass 28 and horizontally extending surface 154, 154′ extends a horizontal distance (shown by double arrow W in FIG. 7) large enough to allow condensates to settle on its surface between vertically extending surface 152, 152′ and blocking ring 164. In certain exemplary embodiments, blocking ring can extend a vertical distance (shown by double arrow B in FIG. 7) ranging from about 0.5 inches to about 1 inch above horizontally extending surface 154, 154.′

In certain exemplary embodiments, condensate catcher 150, 150′ comprises the same material as wall 140. In certain exemplary embodiments, condensate catcher 150, 150′ comprises a metal selected from at least one of platinum, iridium, rhodium, osmium, ruthenium and palladium, or alloys thereof. In certain exemplary embodiments, condensate catcher 150, 150′ comprises platinum, including at least one alloy comprising platinum, such as an alloy comprising platinum and rhodium, such as a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

The condensate catcher 150, 150′ inhibits the transportation of a precious metal or precious metal oxide into molten glass 28. For example, where the mixing vessel 36 comprises a platinum/rhodium alloy and houses an oxygen rich atmosphere above the molten glass 28, the following redox reaction can occur:

$$Pt \cdot Rh + {O}_{2} \to Pt \cdot {RhO}_{2}$$

Such reaction can result in the presence of undesirable amounts of platinum and/or rhodium oxides setting from the atmosphere into the molten glass 28. This reaction also allows the formation of precious metal gas that is now available as a source for defect formation through the reverse reaction:

$$Pt \cdot {RhO}_{2} \to {O}_{2} + Pt \cdot Rh$$

This reverse step can also involve other reactions, such as the redox reaction of a multivalent element (SnO/SnO₂, FeO/Fe₂O₃, etc.). The condensate catcher 150, 150′ can allow these defects to settle on horizontally extending surface 154, 154′ instead of within the main body of molten glass 28 housed within mixing vessel 36. By settling out these defects on the condensate catcher 150, 150′ instead of the main body of molten glass 28, glass articles, such as glass sheets, can be produced having a lower presence of undesirable defects. Such glass articles can be used, for example, in electronic devices, wherein the glass articles have higher quality characteristics.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. A glass mixing vessel comprising:
a wall circumferentially surrounding an inner chamber and a rotatable center shaft;
a removable lid covering the inner chamber and circumferentially surrounding the rotatable center shaft; and
a condensate catcher positioned between the removable lid and the wall, the condensate catcher comprising a vertically extending surface and a horizontally extending surface, the vertically extending surface having an inner diameter that is greater than an inner diameter of the horizontally extending surface.

2. The glass mixing vessel of claim 1, wherein an outer diameter of the condensate catcher is greater than an outer diameter of the wall.

3. The glass mixing vessel of claim 2, wherein the condensate catcher is permanently affixed to the wall.

4. The glass mixing vessel of claim 2, wherein a plurality of gussets extend radially along the horizontally extending surface.

5. The glass mixing vessel of claim 2, wherein the inner diameter of the horizontally extending surface equals an inner diameter of the wall.

6. The glass mixing vessel of claim 1, wherein the condensate catcher is removably inserted between the removable lid and the wall, such that an outer diameter of the vertically extending surface is less than an inner diameter of the wall.

7. The glass mixing vessel of claim 1, wherein a blocking ring extends along an inner diameter of the horizontally extending surface.

8. The glass mixing vessel of claim 1, wherein condensate catcher comprises platinum.

9. The glass mixing vessel of claim 1, wherein the condensate catcher comprises the same material as the wall.

10. A method of manufacturing a glass article comprising;
processing molten glass within a glass mixing vessel, the glass mixing vessel comprising:
a wall circumferentially surrounding an inner chamber and a rotatable center shaft;
a removable lid covering the inner chamber and circumferentially surrounding the rotatable center shaft; and
a condensate catcher positioned between the removable lid and the wall, the condensate catcher comprising a vertically extending surface and a horizontally extending surface, the vertically extending surface having an inner diameter that is greater than an inner diameter of the horizontally extending surface.

11. The method of claim 10, wherein an outer diameter of the condensate catcher is greater than an outer diameter of the wall.

12. The method of claim 11, wherein the condensate catcher is permanently affixed to the wall.

13. The method of claim 11, wherein a plurality of gussets extend radially along the horizontally extending surface.

14. The method of claim 11, wherein the inner diameter of the horizontally extending surface equals an inner diameter of the wall.

15. The method of claim 10, wherein the condensate catcher is removably inserted between the removable lid and the wall, such that an outer diameter of the vertically extending surface is less than an inner diameter of the wall.

16. The method of claim 10, wherein a blocking ring extends along an inner diameter of the horizontally extending surface.

17. The method of claim 10, wherein condensate catcher comprises platinum.

18. The method of claim 10, wherein the condensate catcher comprises the same material as the wall.

19. A glass article made by the method of claim 18.

20. An electronic device comprising the glass article of claim 19.
